(19) United States
(12) Patent Application Publication
(10) Pub. No.: US 2015/0043196 A1
(43) Pub. Date: Feb. 12, 2015

(54) BACKLIGHT SYSTEM WITH MODULAR LIGHT EMITTING DIODE ASSEMBLIES

(71) Applicant: THE HOWARD COMPANY, INC., Brookfield, WI (US)

(72) Inventors: Ty Fleig, Lake Mills, WI (US); Paul Steinbrenner, West Bend, WI (US)

(73) Assignee: THE HOWARD COMPANY, INC., Brookfield, WI (US)

(21) Appl. No.: 13/964,793

(22) Filed: Aug. 12, 2013

(51) Int. Cl. G09F 13/18

(52) U.S. Cl. CPC G09F 13/18
USPC 362/97.3

(57) ABSTRACT

A modular backlight display board employs an extrusion that receives multiple LED modules that may be assembled together with end connectors. By trimming the extrusion to different lengths and installing different numbers of LED modules within the extrusion, a wide variety of different widths of backlight can be readily created.

### BACKGROUND OF THE INVENTION

The present invention relates to backlighted signs, and more particularly to a versatile backlighting system using energy-efficient light emitting diodes (LEDs) having improved repairability.

Menu boards for restaurants and other retail displays often employ an image transparency, for example a photograph, illuminated from behind by a backlight. in many signs of this type the backlights are plastic light diffusers positioned in front of one or more fluorescent tubes electrical lamps. Recently, with the advent of high-powered light emitting diodes, the fluorescent tubes electrical lamps have been replaced by arrays of light emitting diodes.

The light emitting diodes may be positioned at the edge of a light spreader (for example a sheet of transparent plastic) extending behind the transparency. The light spreader serves as a light pipe conducting the light from the light emitting diodes into the sheet and directing the conducted light out a front surface of the sheet to backlight a photographic image positioned over that front. The light spreader may include grooves or other features to promote the spreading of light and improve the uniformity of the backlighting.

Backlighted signs now compete against large area liquid crystal display (LCD) displays of the type used as computer monitors. While both systems can provide bright, color saturated, high-resolution displays, LCD displays are relatively costly, difficult to install, and limited in size and aspect ratio options. The limited and uniform dimensions of LCD displays can make them difficult to integrate into a particular retail environment and can work against a desire for visual novelty important in capturing consumer attention.

### SUMMARY OF THE INVENTION

The present invention provides a backlight display board having a modular design permitting the construction of backlighted signs in a variety of aspect ratios and sizes. The modularity extends to the LEDs themselves and permits, by replacement of individual LED modules, repair of the backlighted signs when an LED fails thus substantially increasing the service life of the sign. Multiple modular, backlight display boards can be combined, according to the present invention, with a simple low voltage electrical harnessing system and without extensive remodeling.

In one embodiment, the invention provides a backlight display board having a planar light spreader receiving light along its edge to direct the light outward from a front surface of the planar light spreader generally perpendicular to the edge. A frame portion receives the edges to support the same and holds at least two LEDs, each module exposing on one surface a set of LEDs extending along a line between ends of the modules. This line is positioned adjacent to the edge and aligned with the edge of the planar light spreader when the planar light spreader is supported within the frame portion. The ends of the modules further have releasable electrical connectors to communicate electricity with an engaging electrical connector on a different LED module.

It is thus a feature of at least one embodiment of the invention to provide an LED backlight display board that may be flexibly produced in a variety of different sizes by interconnection of different numbers of LED modules. It is a further feature of at least one embodiment of the invention to provide an LED backlight display board permitting simple repair by unplugging and replacing an LED module without the need to replace all LEDs or the entire display board.

Each releasable electrical connector may provide for a positive and negative connection and the LED modules may further provide positive and negative power rails extending along their length with the positive power rail joining corresponding positive connections of the releasable electrical connectors and the negative power rail joining corresponding negative connections of the releasable electrical connectors and the LEDs may be connected between the positive power rail and negative power rail.

It is thus a feature of at least one embodiment of the invention to provide an interconnectable LED module that joins the LEDs of different modules in parallel and thus eliminates problems of variable voltage (and illumination) drop when different numbers of LED modules are assembled together.

The LED modules may include an additional electrical connector not on an end of the LED module for engaging a wiring harness.

It is thus a feature of at least one embodiment of the invention to provide a simple method of interconnecting separate banks of LED modules either within the same sign or between signs at a location removed from the ends of the LED modules for convenient interconnection.

The additional electrical connector may provide for a positive and negative connection connected to the positive power rail and negative power rail respectively.

It is thus a feature of at least one embodiment of the invention to allow power to be introduced to any one of a set of interconnected LED modules so that it may then be communicated to all connected LED modules.

The backlight display board may further include a wiring harness for connecting to two different additional electrical connectors on different LED modules to join corresponding positive and negative connections of the additional electrical connectors.

It is thus a feature of at least one embodiment of the invention to allow multiple interconnected sets of LED modules to be joined to a common power supply in parallel to avoid problems of varying voltage drop as may affect LED illumination or require special adjustment of the power supply.

The LED modules include LED modules of different lengths. In one embodiment, a smaller length is substantially evenly divisible into a larger length. In one embodiment, different lengths are six inches and two inches.

It is thus a feature of at least one embodiment of the invention to provide a fine increment of variation in signs sizes without unnecessarily increasing the number and cost of the assembled LEDs. It is a further feature of at least one embodiment of the invention to provide a fine increment of variation in sign sizes while providing adequate size in at least one LED module for a third connector for the introduction of power to the interconnected LED modules.

The LED modules may each be a printed circuit board having traces joining the connectors and LEDs.

It is thus a feature of at least one embodiment of the invention to provide a simple structure for supporting and electrically interconnecting multiple LEDs for more uniform edge lighting.

The electrical connectors may be hermaphroditic, that is capable of connecting with an identical connector.

It is thus a feature of at least one embodiment of the invention to reduce the parts count for the backlight display board and thereby its total cost.

The frame portion may provide a channel slidably receiving the LED modules along edges of the LED modules.

It is thus a feature of at least one embodiment of the invention to provide for a simple assembly technique that allows a ready replacement of individual LED modules in the event of failure.

The edges of the LED modules may include heat conductive surfaces in thermal communication with the LEDs for communicating heat from the LEDs to the frame portion.

It is thus a feature of at least one embodiment of the invention to provide a method of extracting heat from the LEDs without substantially encumbering an ability to remove the LED module for replacement or install an LED module during manufacture.

The heat conductive surfaces may be power rails of copper conductor on the PCB communicating electrical power to the LEDs.

It is thus a feature of at least one embodiment of the invention to make use of the copper of the printed circuit board for both heat and electrical conduction thereby allowing more compact and less expensive structure.

The metallic frame portion may be formed of a metallic extrusion of constant cross-section, for example, an aluminum extrusion.

It is thus a feature of at least one embodiment of the invention to provide a structure that can incorporate the complex surfaces necessary for edge lighting and supporting a light spreader and yet which can nevertheless be readily trimmed to different lengths to provide signs of different sizes.

The extrusion may include an inwardly extending, backwardly sloped surface adapted for engaging a forwardly sloped surface of a cleat attached to a wall.

It is thus a feature of at least one embodiment of the invention to provide a simple method of ensuring a close fit of the display board against a wall that is also readily installed and removed without tools.

The extrusion may include screw-receiving slots and the sign may further include side panels attached to upper and lower extrusions by means of machine screws passing through the side panels and into the screw-receiving slots.

It is thus a feature of at least one embodiment of the invention to provide a simple assembly method that allows a variety of different sizes of signs to be readily manufactured simply by cutting the extrusions to different lengths and using different numbers and combinations of LED modules.

The side panels may cover the channels holding the LED modules.

It is thus a feature of at least one embodiment of the invention to provide a simple method to both assemble the frame and retain the LED modules.

The extrusion may further include a channel receiving an edge of a planar light spreader

It is thus a feature of at least one embodiment of the invention to incorporate a light spreader support structure into the extrusion to simplify manufacture of the side panels.

Each LED module may be adapted to operate on 24 volts.

It is thus a feature of at least one embodiment of the invention system to work with low voltage wiring, limiting the need for specialized insulation or installation techniques.

These particular objects and advantages may apply to only some embodiments falling within the claims and thus do not define the scope of the invention.

### BRIEF DESCRIPTION OF THE DRAWINGS

FIG. 1 is a perspective view of a backlit display board having a frame surrounding a backlit image transparency;

FIG. 2 is an exploded fragmentary view of an upper rail and side stile of the frame of FIG. 1 showing assembly of the two and showing receipt of a light spreader into the upper rail and insertion of multiple LED modules in channels within the upper rail to be positioned above the light spreader;

FIG. 3 is a cross-section along line 3-3 of FIG. 1 showing the LED modules positioned within the channel of the upper rail and a connector harness joining with one LED module and further showing a downwardly extending extension that may attach to a wall cleat;

FIG. 4 is a perspective view of two LED modules of different sizes showing end connectors and a center terminal together with an expanded view of the underside of the module showing LEDs attached thereto;

FIG. 5 is a front elevational view of the backlit display board showing an assembly of LED modules to provide a variety of different sign widths;

FIG. 6 is a simplified schematic diagram of the circuitry on two different LED modules showing their interconnection to preserve constant-voltage, parallel Operation; and

FIG. 7 is a rear view of two backlight display boards of the present invention showing possible jumping to work with a single power supply.

### DETAILED DESCRIPTION OF THE PREFERRED EMBODIMENT

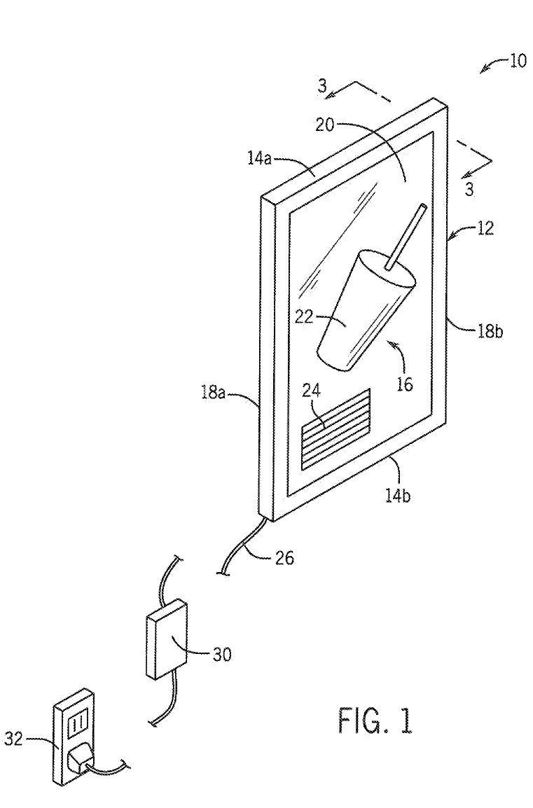

Referring now to FIG. 1 a backlight display board 10 of the present invention may provide a generally rectangular frame 12 having upper and lower horizontal rails 14a and 14b opposed in parallel opposition about a center rectangular panel 16.

The upper and lower horizontal rails 14a and 14b attach at their ends to respective upper and lower ends of vertical stiles 18a and 18b also in parallel opposition about the center rectangular panel 16, the vertical stiles 18a and 18b completing the rectangular frame 12.

A front surface of the rectangular panel 16 displays a image transparency 20 having images 22 and text 24 backlit by an internal mechanism of the backlight display board 10 as will be described.

A low voltage power cord 26 extends from the frame 12, for example, carrying 24 volt DC power received from a power supply 30 which may attach to a standard electrical outlet 32 and may convert 110 volt AC power to 24 volt DC power at 4 ampere constant current. Power supplies of this type are commercially available, for example, from Mean Well USA, Inc., having offices in Fremont, Calif.

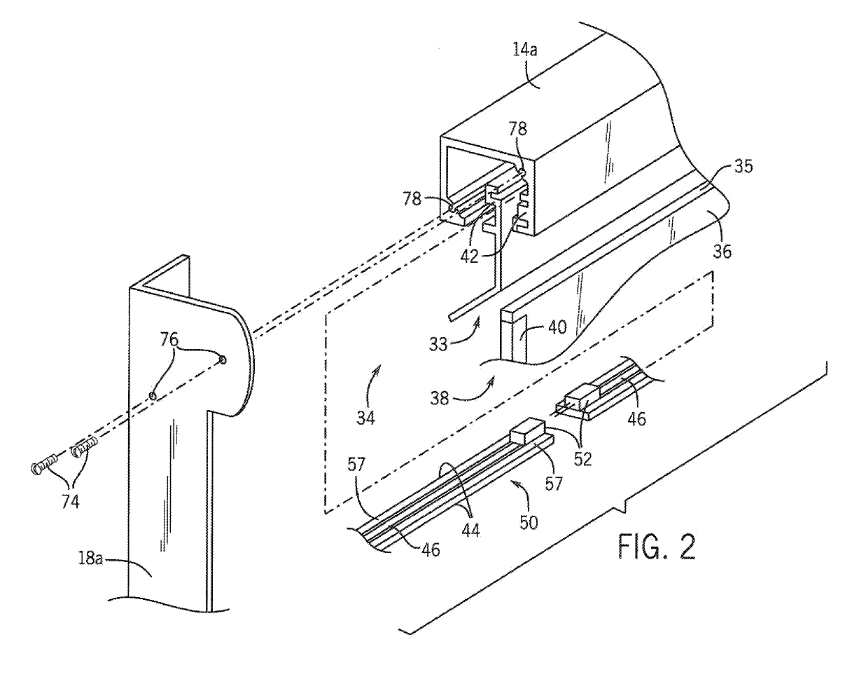

Referring now also to FIG. 2, the upper and lower horizontal rails 14a and 14b may be identical aluminum extrusions having a generally rectangular cross-section open at inner edges 34 along a slot 33 to receive the upper and lower edges 35 of a light spreader 36. The light spreader 36 may be, for example, a transparent sheet of acrylic or polycarbonate plastic, for example, one quarter inch thick.

As will be discussed, the upper and lower edges 35 will receive illumination which will be conducted by the light spreader 36 over the area of the panel 16 to provide a uniform backlighting. For this purpose, side edge 38 of the light spreader 36 may be covered with reflective tape 40 to help retain the light within the light spreader 36.

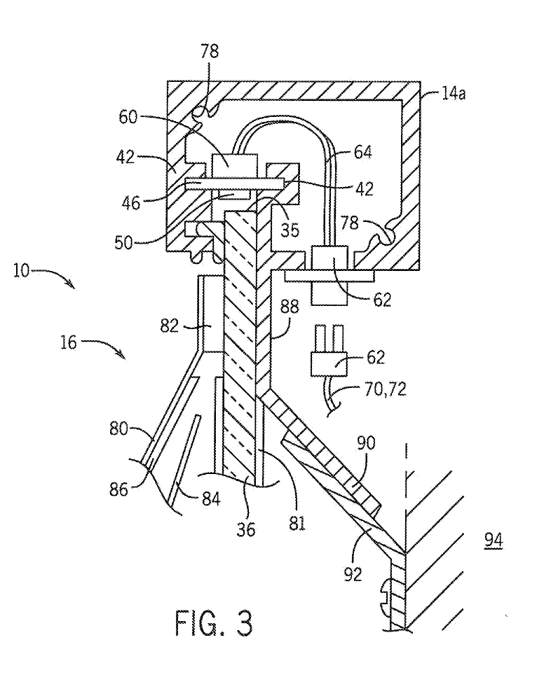

Referring also to FIG. 3, within each of the horizontal rails 14a and 14b and aligned with and displaced on the outside of slot 33 are channels 42 which may slidably receive left and right edges 44 of LED modules 46. The LED modules 46 may be constructed of strips of printed circuit board material such as fiberglass epoxy composite, for example, having a nominal thickness of 0.062 inches, a width of 0.50 inches and one of two different lengths of substantially two or six inches as will be discussed below. As so supported in the channels 42, the LED modules 46 extend generally perpendicular to a plane of the light spreader 36 across edge 35 of the light spreader 36.

Referring now to FIGS. 2, 3 and 4, an inner surface of the LED modules 46 may support a linear array of LEDs 50 attached by surface mounting along a centerline of the LED module 46 along the length of each LED module 46. When the LED modules 46 are held within the channels 42, the LEDs 50 are positioned above and proximate to the upper edge 35 of the light spreader 36 to project light directly into that edge. LEDs suitable for this purpose include those commercially available from Cree, Inc. of Durham, N.C. under the trade name XLamp.

Each of the LED modules 46 has on its opposed ends separated by a length of the LED module 46, outwardly facing hermaphroditic electrical connectors 52 allowing multiple LED modules 46 to be electrically connected together in a single line that may be received by the channels 42 of the rails 14. Hermaphroditic in this context means that each electrical connector will properly connect with another connector of identical design. Electrical connectors 52 suitable for this purpose are available commercially from Tyco under the trade designation 19542891. The connectors 52 are arranged so that the ends of successive printed circuit boards of the LED modules 46 abut and even spacing is preserved between the LEDs 50 within and across different LED modules 46.

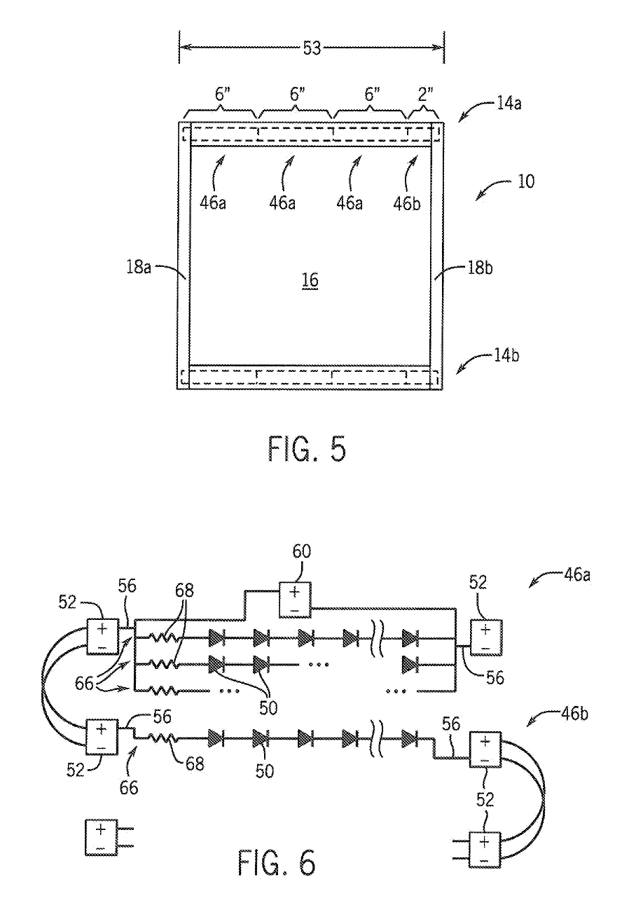

Referring also to FIG. 5, as noted above, to different lengths of LED modules 46 may be provided of two and six inches respectively. By combining different numbers of these LED modules 46, a wide variety of different widths 53 of backlight display board 10 may be obtained from six inches to an arbitrary length in two-inch increments, for example six inches, eight inches, 10 inches, 12 inches etc. The ultimate widths 53 of the backlight display board 10 is limited only by the capabilities of the power supply 30 to provide the necessary current to the parallel connected LED modules 46.

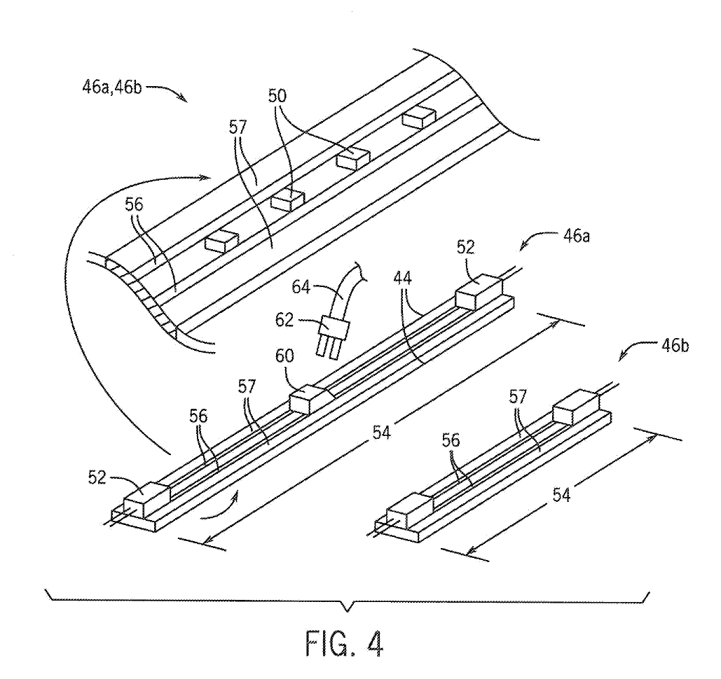

Referring again to FIG. 4, the connectors 52 on opposite ends of each LED module 46 convey electrical power between each other by power rails 56 running along the edges of the LED modules 46 over their length. This interconnection of the connectors 52 allows electrical power to be received by all LED modules 46 in a chain connected by connectors 52 when only one LED module 46 is connected to power. The power rails 56 may be flanked by strips of copper 57 on the upper and lower surfaces of the printed circuit board of the modules 46. These strips of copper 57 are in close thermal communication with the channel 42 and hence with the extrusions of the rails 14. in this way the strips of copper 57 can provide a thermal heat sink path for the LEDs 50. In particular, a neutral thermal via of the LED package may be connected for each LED 50 to one or both of the strips of copper 57 to provide thermal conduction thereto and into the channel of the rail 14.

At a midpoint along the length of a six-inch LED module 46a, a printed circuit board supported terminal 60 may attach to the printed circuit board and connect with the power rails 56. The terminal 60 provides a point of releasable electrical connection with a harness connector 62 in turn attached to short flexible electrical harness 64. Terminals and connectors suitable for this purpose are manufactured by WAGO Corporation having offices in Wisconsin, USA. For all different sizes of the backlight display boards 10 at least one LED module 46a is provided in each of the rails 14a and 14b having the terminal 60 to permit the introduction of electrical power thereto.

Referring now to FIG. 3 an opposite end of the harness 64, also having a connector 62, may be exposed at an inner surface of the channel of the rails 14 behind the light spreader 36 to provide a method of introducing power into the rails 14 that is not visible to the user being behind the light spreader 36.

Referring now to FIG. 6, each of the six-inch LED modules 46a may include three ranks 66 of LEDs 50, each rank, for example, including seven, series-connected LEDs 50 in series with a limiting resistor 68. The ranks 66 are physically in succession along the length of the LED module 46 so that each rank provides illumination for a two-inch length along LED module 46. Each of the ranks 66 is placed in parallel across the power rails 56 to operate properly at 24 volts.

In contrast, the two-inch LED module 46b provides only a single rank 66 placed between the power rails 56.

Generally the connectors 52 of each LED module 46 are wired so that joining together of modules 46 provides electrical continuity of the power rails 56. Thus as additional modules 46 are connected together, additional ranks 66 are added in parallel. This parallel connection eliminates any problem of voltage drop that would occur with a series connection and practically allows arbitrary numbers of modules 46 to be connected in series up to a current limit of the power supply without the need for adjustment or changing of the power supply.

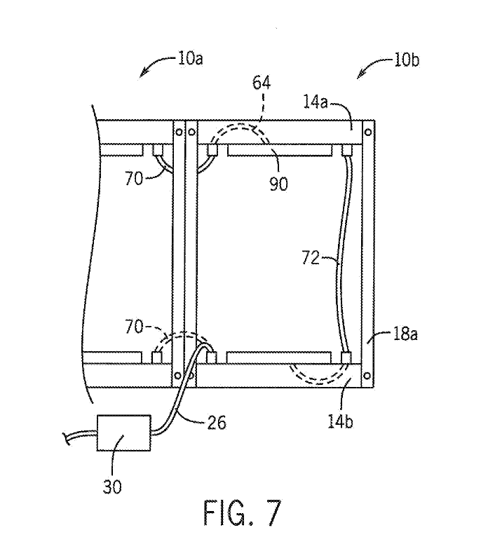

Referring now also to FIG. 7, this same principle may be used to allow multiple rails 14 or multiple backlight display boards 10a and 10b to be daisy-chained together with a single power supply, for example, by jumper cables 72 extending between upper rails 14a or lower rails 14b or jumper cables 70 extending between successive backlight display boards 10a and 10b. The jumper cables 72 or 72 may provide the same connector type as connectors 62, and like the connectors 52, may join LED modules 46 to provide electrical continuity of the power rails 56.

Referring again to FIG. 2, the stiles 18 may be simply attached to the rails 14 by machine screws 74 passing through corresponding holes 76 in the stiles 18 and into the receiving slots 78 formed in the extrusion of the rails 14. The stiles 18 may be simple cut and folded strips of metal providing relatively low fabrication costs.

Referring again to FIG. 3, a front surface of the light spreader 36 may be coverable with a flexible vinyl sheet 80 attached, for example, at an upper edge of the panel 16 by a spacer strip 82. An image transparency 84, being a photographic transparency or the like, may thus be sandwiched between the flexible vinyl sheet 80 and a front surface of the light spreader 36. Strip magnets 86 may be attached around the periphery of the vinyl sheet 80 and the exposed face of the light spreader 36 to hold the vinyl sheet tightly against the image transparency 84 when the latter is installed between the vinyl sheet 80 and the light spreader 36. A rear face of the light spreader 36 may provide for a reflective backing film 81.

Referring still to FIG. 3, an alignment surface 88 of the channel of the rails 14 may extend downward from a rear edge of the slot 33 parallel to a rear surface of the light spreader 36 and then may angle backward to provide an angled tab 90 that may be received by an upper surface of a cleat 92 extending in an angle forward complementary to the backward angle of the tab 90 and attached to a wall 94 or the like to support the upper channel of the rail 14a thereagainst. The angled interface between the angled tab 90 and an upper surface of the cleat 92 serves to pull the backlight display board 10 against the wall 94.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. A backlight display board comprising:
a planar light spreader receiving light along at least one edge to direct the light outward from a front surface of the planar light spreader generally perpendicular to the edge;
a frame portion receiving at least one edge to support the same; and
at least two LED modules releasably supported within the frame portion, each exposing on one surface a set of LEDs extending along a line between ends of the modules, the line positioned adjacent to the edge and aligned with the edge of the planar light spreader when the planar light spreader is supported within the frame portion, the ends of the modules providing releasable electrical connectors to communicate electricity with an engaging electrical connector on a different LED module.

2. The backlight display board of claim I wherein each releasable electrical connector provides for a positive and negative connection and wherein the LED modules provide positive and negative power rails extending along their length with the positive power rail joining corresponding positive connections of the releasable electrical connectors and the negative power rail joining corresponding negative connections of the releasable electrical connectors and wherein the LEDs are connected between the positive power rail and negative power rail.

3. The backlight display board of claim 2 wherein at least one of the LED modules includes an additional electrical connector not on an end of the LED module for engaging a wiring harness.

4. The backlight display board of claim 3 wherein the additional electrical connector provides for a positive and negative connection connected to the positive power rail and negative power rail respectively.

5. The backlight display board of claim 3 further including a wiring harness for connecting to two different additional electrical connectors on different LED modules to join corresponding positive and negative connections of the additional electrical connectors.

6. The backlight display board of claim 1 wherein at least two LED modules include LED modules of different lengths.

7. The backlight display board of claim 6 wherein a smaller length is substantially evenly divisible into a larger length.

8. The backlight display board of claim 1 wherein the different lengths are six inches and two inches.

9. The backlight display board of claim 1 wherein the LED modules each comprise a printed circuit board having traces joining the connectors and LEDs.

10. The backlight display board of claim 1 wherein the electrical connectors are hermaphroditic.

11. The backlight display board of claim 1 wherein the frame portion provides a channel slidably receiving the LED modules along edges of the LED modules.

12. The backlight display board of claim 11 wherein the edges of the LED modules include heat conductive surfaces in thermal communication with the LEDs for communicating heat from the LEDs to the frame portion.

13. The backlight display board of claim 12 wherein the LED module comprises a printed circuit board joining the connectors and LEDs and wherein the heat conductive surfaces are power rails of copper conductor on the printed circuit board communicating electrical power to the LEDs.

14. The backlight display board of claim 1 wherein the frame portion is formed of a metallic extrusion of constant cross-section.

15. The backlight display board of claim 14 wherein the extrusion is an aluminum extrusion.

16. The backlight display board of claim 14 wherein the extrusion includes an inwardly extending backwardly sloped surface adapted for engaging a forwardly sloped surface of a cleat attached to a wall.

17. The backlight display board of claim 14 wherein the extrusion includes screw-receiving slots and further includes side panels attached to upper and lower extrusions by means of machine screws passing through the side panels and into the screw-receiving slots.

18. The backlight display board of claim 14 wherein the extrusion provides a channel slidably receiving the LED modules along edges of the LED modules and the side panels cover the channel.

19. The backlight display board of claim 1 wherein the frame portion includes a channel receiving an edge of a planar light spreader.

20. The backlight display board of claim 1 wherein each LED module is adapted to operate on 24 volts.
